(19) United States
(12) Patent Application Publication
(10) Pub. No.: US 2025/0081894 A1
(43) Pub. Date: Mar. 13, 2025

(54) BRACKET FOR HORIZONTAL HANGER TUBE SUPPORT

(71) Applicant: Joseph Ermalovich, Santa Barbara, CA (US)

(72) Inventor: Joseph Ermalovich, Santa Barbara, CA (US)

(21) Appl. No.: 18/830,684

(22) Filed: Sep. 11, 2024

Related U.S. Application Data
(60) Provisional application No. 63/581,749, filed on Sep. 11, 2023.

(51) Int. Cl. A01F 25/12

(52) U.S. Cl. CPC A01F 25/12

(57) ABSTRACT

A hanger tube support bracket has a body flange with a pair of tube support hooks forwardly extending from the body flange to receive a hanger tube. At least one upper engagement tangs and at least one lower engagement tang extend rearwardly from the body flange to be received in corresponding upper and lower engagement apertures in a web of an upright column of a support frame. The at least one upper engagement tang engaging the web adjacent a lower portion of the upper engagement aperture and the at least one lower engagement tang engaging the web adjacent a lower portion of the lower engagement aperture.

### REFERENCES to RELATED APPLICATIONS

This application claims priority of U.S. Provisional Application Ser. No. 63/581,749 filed on Sep. 11, 2023 entitled BRACKET FOR HORIZONTAL HANGER TUBE SUPPORT, having a common inventor with the current application, the disclosure of which is incorporated herein by reference.

### BACKGROUND

### Field

This invention relates generally to the field of support frames and more particularly to a novel bracket adapted to engage hanger tubes for attachment to upright frames having standard extended cylindrical attachment apertures.

### Description of the Related Art

Rack arrangements for pallet support, general shelving and agricultural drying racks typically employ upright metal columns with arrays of apertures to engage horizontal and lateral beams to form frames. Pallet or shelf support frames have been standardized with upright columns having arrays of apertures spaced on each column to engage protruding attachment elements extending from mating beams or accessories. The protruding attachment elements are typically a cylindrical extension with a circular cap which is received in a circular opening having a diameter to accept insertion of the cap with a descending slot having a width to accept the cylindrical extension while securing the inserted circular cap.

However, for brackets to engage hanger tubes or support other subsidiary elements on the racks, cylindrical extensions and caps are difficult to align and secure in the apertures in the upright columns.

It is therefore desirable to provide a bracket for hanger tubes which is easily attachable to vertical columns in a support frame and provides stable tube support.

### SUMMARY

A first implementation disclosed herein provides a hanger tube support bracket having a body flange with a pair of tube support hooks forwardly extending from the body flange. An upper pair of engagement tangs and a lower pair of engagement tangs extend rearwardly from the body flange to be received in corresponding upper and lower pairs of engagement apertures in a web of an upright column of a support frame. The upper pair of engagement tangs have upper engagement slots adapted to capture the web with a lower edge of the lower pair of engagement apertures abutting an upper extent of the upper engagement slots and the lower pair of engagement tangs have lower engagement slots adapted to capture the web with a lower edge of the lower pair of engagement apertures abutting an upper extent of the lower engagement slots.

A second implementation disclosed herein provides a hanger tube support bracket having a body flange with a pair of tube support hooks forwardly extending from the body flange and a pair of side flanges rearwardly extending from the body flange to engage opposing sides of an upright Unistrut column of a support frame. An upper engagement tang and a lower engagement tang extend rearwardly from the body flange to be received in corresponding upper and lower engagement apertures in a web of the upright Unistrut column. The lower engagement tang extends at a first angle rearwardly from the body flange and is adapted to capture the web with a lower face abutting a lower extent of the lower engagement aperture and the upper engagement tang extends at a second angle rearwardly from the body flange capture the web with a lower face of the upper engagement tang abutting a lower extent of the upper engagement aperture.

A hanger tube endplate is disclosed as received in an open end of the hanger tube to engage an inner face of one of the support hooks to longitudinally restrain the hanger tube in the bracket.

### BRIEF DESCRIPTION OF THE DRAWINGS

These and other features and advantages of the present invention will be better understood by reference to the following detailed description of exemplary implementations when considered in connection with the accompanying drawings wherein:

FIG. 1 is a pictorial view of a partial support frame in which a first exemplary bracket implementation is employed for upright columns with multiple vertical arrays of engagement apertures;

FIG. 2 is a pictorial view of a portion of an upright column on which the bracket is engaged and supporting a hanger tube;

FIG. 3 is a pictorial view of the portion of the upright column with the bracket disengaged;

FIG. 4 is a pictorial view of the portion of the upright column with the bracket inserted in the engagement apertures;

FIG. 5A is a pictorial front view of the first exemplary implementation of the bracket showing details of the engagement tangs and the tube support hooks;

FIG. 5B is a pictorial rear view of the first exemplary implementation of the bracket showing details of the engagement tangs and the tube support hooks;

FIG. 6 is a side view of the first exemplary implementation of the bracket of FIGS. 5A and 5B;

FIGS. 7A-7D are side views demonstrating a sequence of insertion of the first exemplary implementation of the bracket into the associated engagement apertures in the upright column;

FIG. 8 is a side section view of the upright column and engaged bracket;

FIG. 9 is a pictorial view of a partial support frame in which a second exemplary bracket implementation is employed for upright Unistrut columns with a single vertical array of engagement apertures;

FIG. 10 is a pictorial view of a portion of an upright column on which the bracket is engaged and supporting a hanger tube;

FIG. 11 is a pictorial view of the portion of the upright column with the bracket disengaged;

FIG. 12 is a pictorial view of the portion of the upright column with the bracket inserted in the engagement apertures;

FIG. 13A is a pictorial front view of the second exemplary implementation of the bracket showing details of the engagement tangs and the tube support hooks;

FIG. 13B is a pictorial rear view of the second exemplary implementation of the bracket showing details of the engagement tangs and the tube support hooks;

FIG. 14 is a side section view of the second exemplary implementation of the bracket of FIGS. 13A and 13B;

FIGS. 15A-15D are side views demonstrating a sequence of insertion of the second exemplary implementation of the bracket into the associated engagement apertures in the Unistrut column;

FIG. 16 is a side section view of the Unistrut upright column and engaged bracket;

FIG. 17A is a pictorial front view of an endplate implementation for the tube supports received in the exemplary implementations of the bracket;

FIG. 17B is a pictorial front view of an alternative endplate implementation for the tube supports received in the exemplary implementations of the bracket;

FIG. 18A is a pictorial front view of the endplate inserted in a tube support;

FIG. 18B is a pictorial front view of the alternative implementation of the endplate inserted in a tube support;

FIG. 19 is a pictorial left front view of tube supports with engaged endplates received on the second exemplary implementation of the bracket; and,

FIG. 20 is a pictorial right front view of a tube support with an engaged endplate as a termination received on the second exemplary implementation of the bracket.

### DETAILED DESCRIPTION

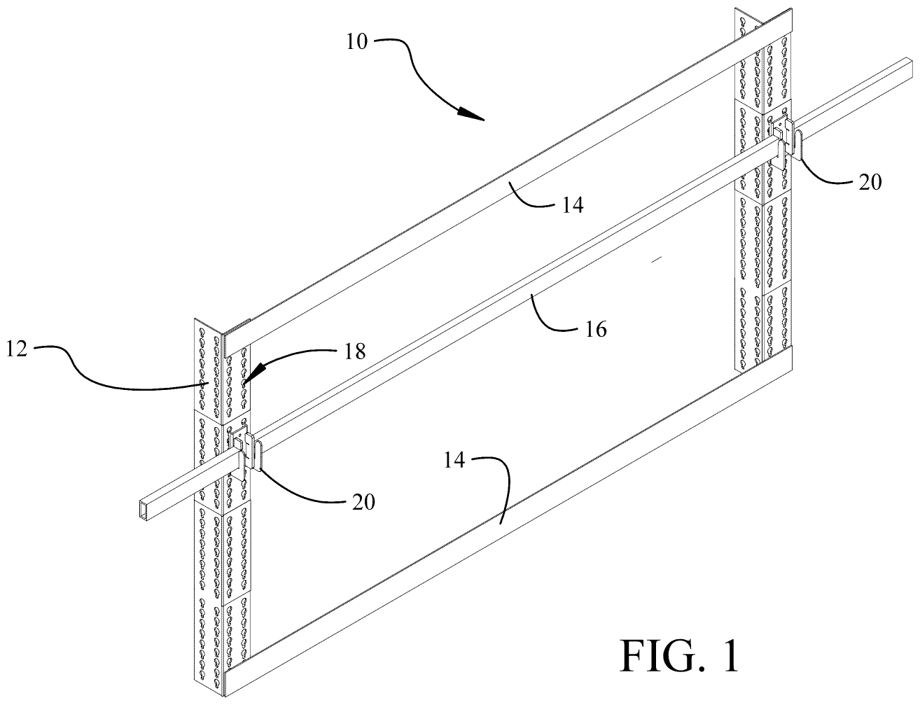

Implementations shown in the drawings and described herein provide a hanger tube support bracket for attachment to upright columns in a support frame. As shown in FIG. 1 for a first exemplary implementation, a support frame 10 has upright columns 12 which may be connected by beams 14. In various agricultural drying racks, hanger tubes 16 attached to the upright columns are employed to support agricultural product drying hangers such as disclosed in US design application Ser. No. 29/899,829 filed on Aug. 14, 2023 entitled CANNABIS HANGER. The upright columns 12 have two vertical arrays of engagement apertures 18 in the web 19 of the columns to secure the beams 14 and hanger tube support brackets 20 to form a cannabis drying support system.

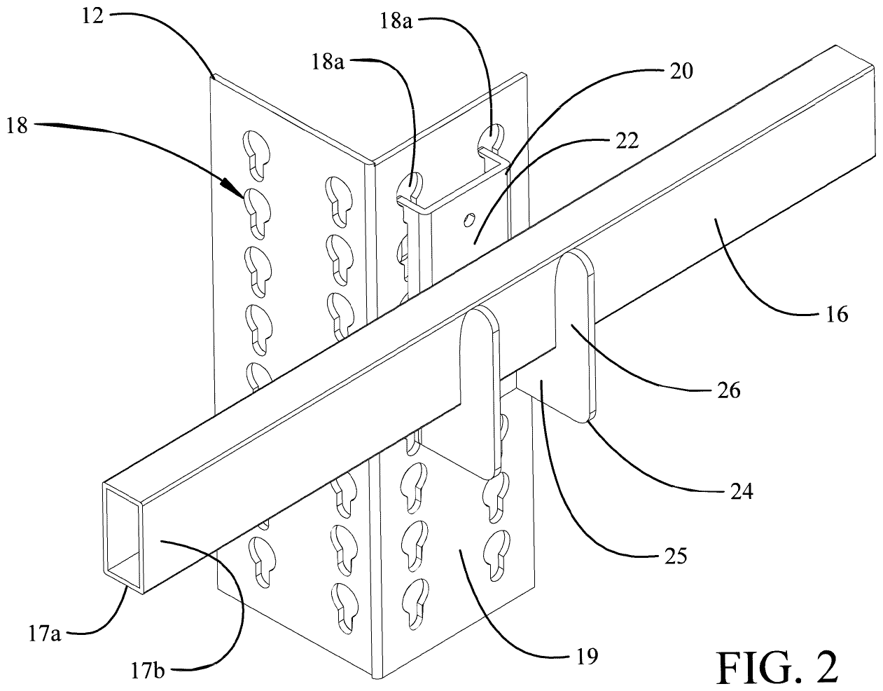

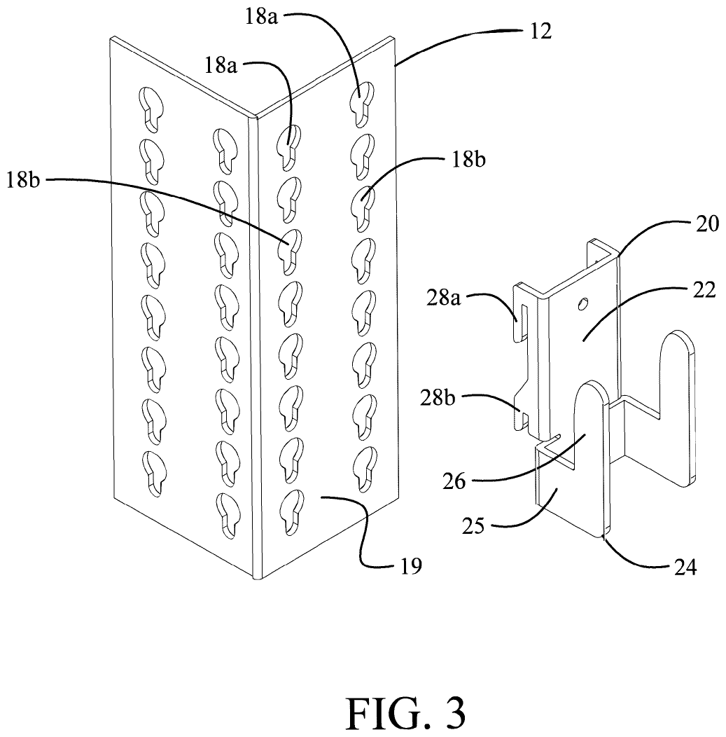

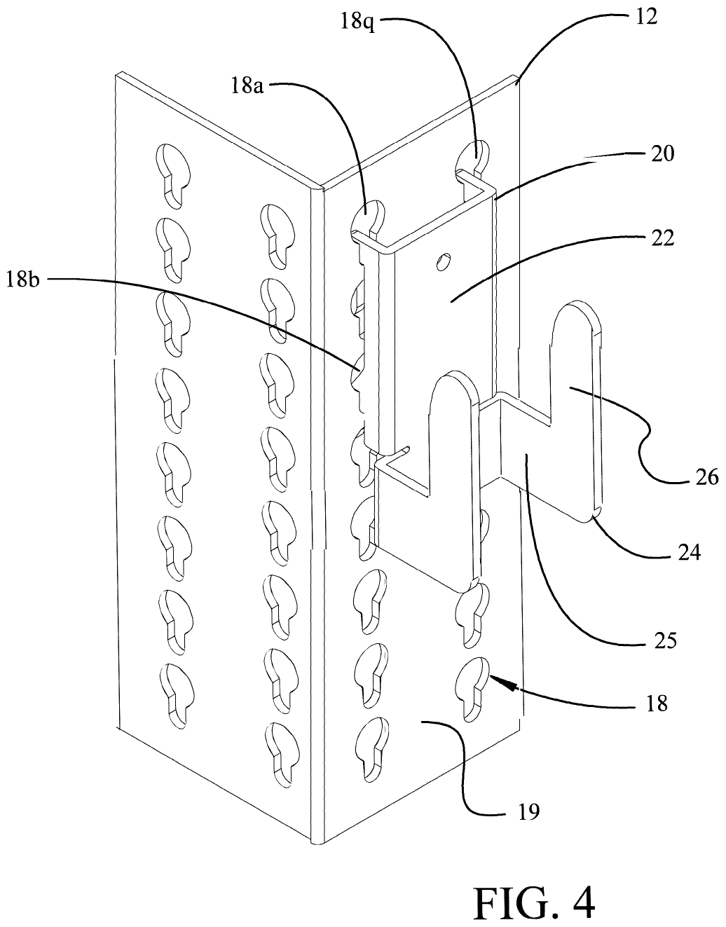

As seen in greater detail in FIG. 2, FIG. 3 and FIG. 4, the first exemplary implementation of the hanger support brackets 20 have a body flange 22 with forwardly extending tube support hooks 24 having horizontal arms 25 and risers 26 to support and constrain the hanger tubes 16. Pairs of engagement tangs 28a and 28b extend rearwardly from the body flange 22, the opposite direction from the support hooks with respect to the body flange, to be received in corresponding pairs of engagement apertures 18a and 18b in the upright columns 12. The arrays of engagement apertures 18 may be spaced to provide vertical adjustments of the brackets which result in intermediate aperture pairs between the apertures receiving the engagement tangs; one intermediate pair shown in the examples in the drawings. The engagement apertures shown in the drawings adopt the circular opening having a diameter to accept insertion of a cap with a descending slot having a width to accept a cylindrical extension while securing the inserted circular cap. Alternative shapes for the engagement apertures may be employed such as teardrop or keyhole style. As will be described subsequently, the engagement tangs, while not employing a circular cap, are configured to be received in evenly spaced apertures and employ a slot to rest at the bottom center of whatever aperture shape is employed.

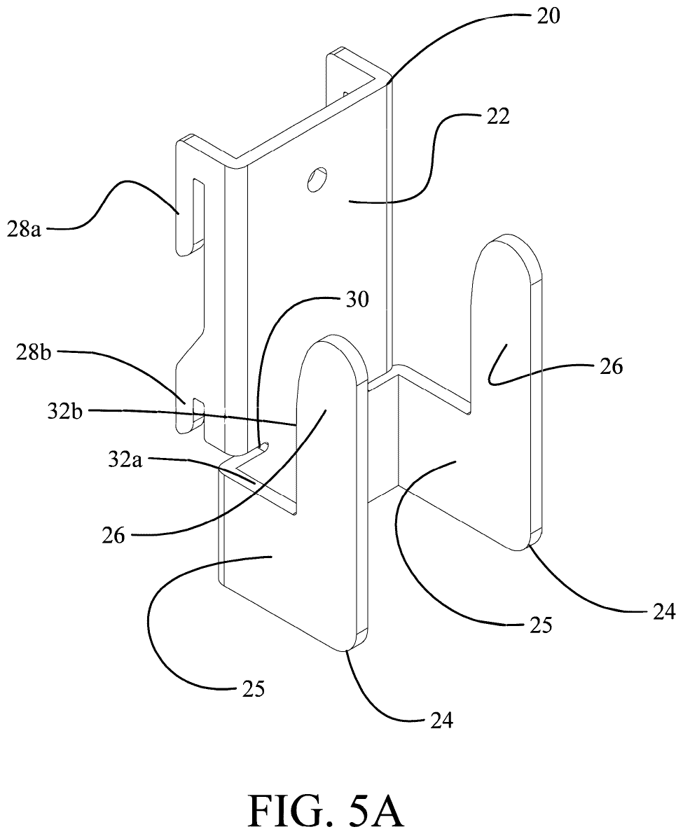

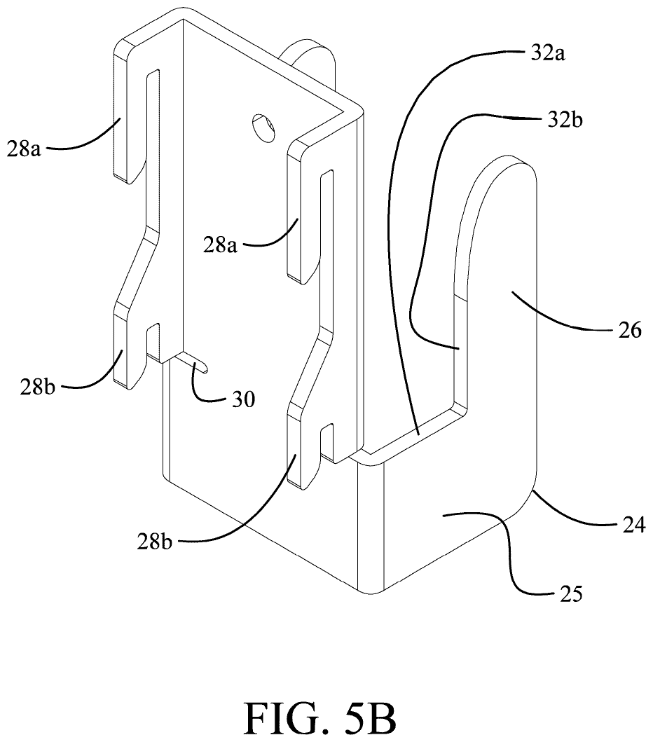

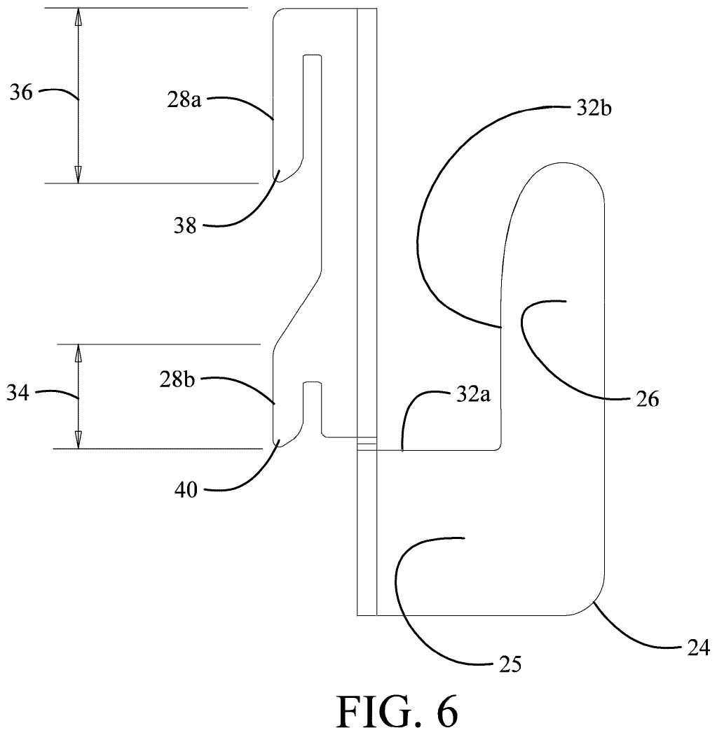

Details of the first exemplary implementation of the hanger tube support bracket 20 are shown in FIGS. 5A, 5B and 6. In the example implementation the hanger support bracket 20 is formed from a flat blank with the support hooks 24 bent forwardly from the body flange 22 and an upper pair of engagement tangs 28a and a lower pair of engagement tangs 28b bent rearwardly from the body flange 22. Reliefs 30 in the body flange are present to facilitate bending.

The support hooks 24 have an upper surface 32a on the horizontal arms 25 to support a lower surface 17a (seen in FIG. 2) of the hanger tube 16. A rear surface 32b on the risers 26 constrains a forward surface 17b (seen in FIG. 2) on the hanger tube 16.

As best seen in FIG. 6, the upper and lower pairs of engagement tangs 28a and 28b are sized to facilitate insertion into the vertically spaced pairs of engagement apertures 18a and 18b. The lower pair of engagement tangs 28b have a first length 34 which is less than a second length 36 of the upper pair of engagement tangs 28a to provide functionality for insertion into the engagement apertures to be described subsequently. The lower portion 38 of the upper pair of engagement tangs 28a is beveled or filleted from front to rear and the lower portion 40 of the lower pair of engagement tangs 28b is also beveled or filleted from front to rear also for insertion functionality.

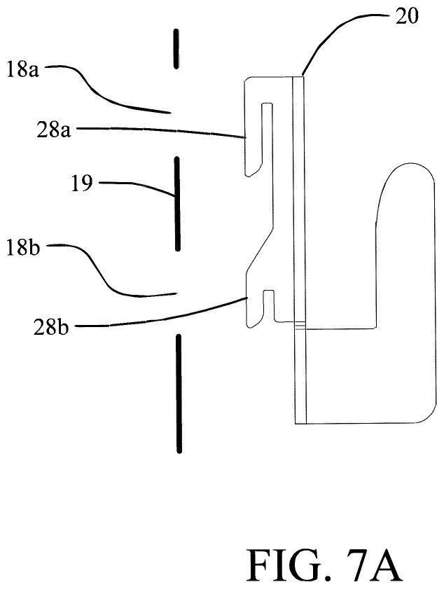

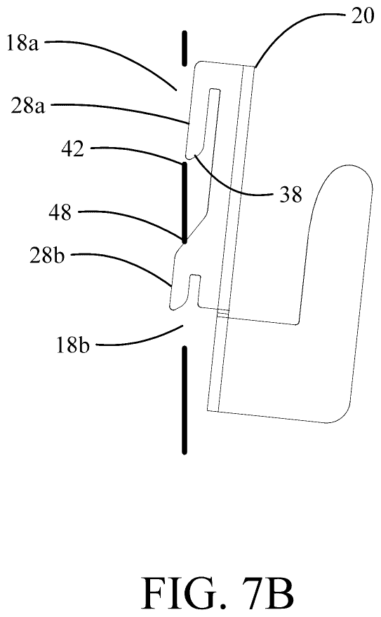

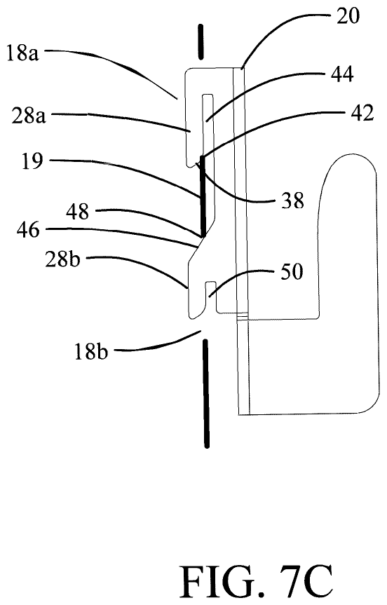

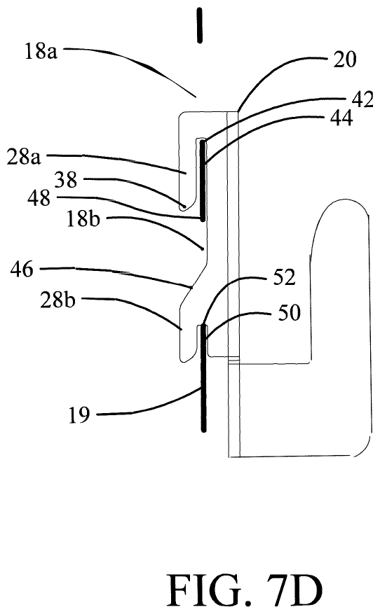

The removable support brackets 20 are attached to the upright columns as shown in FIGS. 7A-7D. As seen in FIG. 7A, support bracket 20 is positioned with the pairs of engagement tangs 28a and 28b adjacent to the associated pairs of engagement apertures 18a and 18b (the web 19 of the upright column shown with only the engagement apertures 18a and 18b and intermediate engagement apertures deleted for clarity). As seen in FIG. 7B, the support bracket is rotated to allow initial insertion of the shorter lower pair engagement tangs 28b into the lower pair of engagement apertures 18b. This allows the longer upper pair of engagement tangs 28a to begin insertion into the upper pair of engagement apertures 18a with the beveled lower portions 38 closely clearing a bottom edge 42 of the engagement apertures. This angular insertion arrangement allows for maximum length of the upper pair of engagement tangs (as long as or slightly longer than the vertical dimension of the engagement apertures).

As seen in FIG. 7C, the support bracket 20 is then rotated back to substantially vertical while beginning to lower the bracket to engage the web of the column in upper engagement slots 44 in the upper pair of engagement tangs 28a. A relief ramp 46 on each of the lower pair of engagement tangs 28b is receivable on an upper edge 48 on each of the lower pair of engagement apertures 18b to mirror close clearance or engagement of the filleted lower portion of the upper pair of engagement tangs on the bottom edge 42 of the upper pair of engagement apertures as the support bracket 20 is urged rearward and downward into the apertures.

As seen in FIG. 7D, upon completion of the downward travel of the support bracket, the web 19 of the column is captured in the upper engagement slots 44 in the upper pair of engagement tangs with lower edge 42 abutting an upper extent of the upper engagement slots and the web is also captured in lower engagement slots 50 in the lower pair of engagement tangs 28b with lower edges 52 of the lower pair of engagement apertures 18b abutting an upper extent of the lower engagement slots.

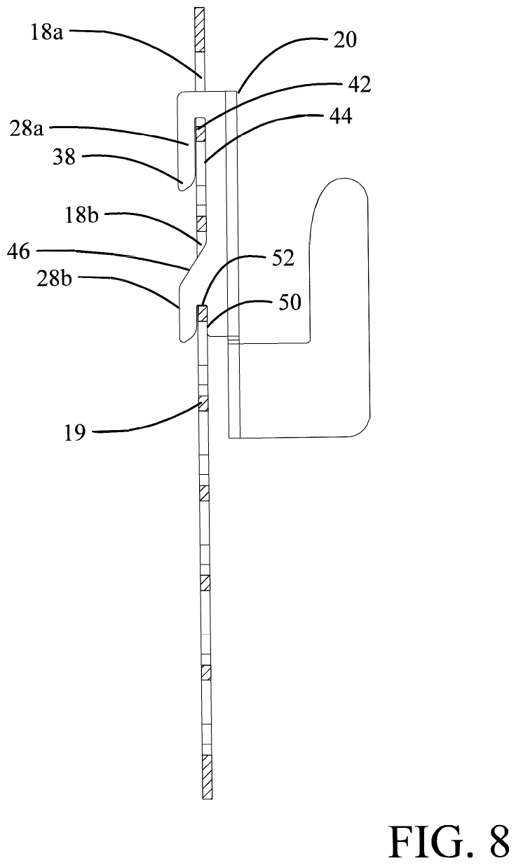

The lateral spacing of pairs of engagement tangs provide stability for the bracket to suspend the hanger support tube by engaging pairs of laterally spaced engagement apertures in the upright columns. The vertical spacing of the pairs of engagement tangs with slotted capture of the column web securely engages the support bracket to the column as shown in FIG. 8.

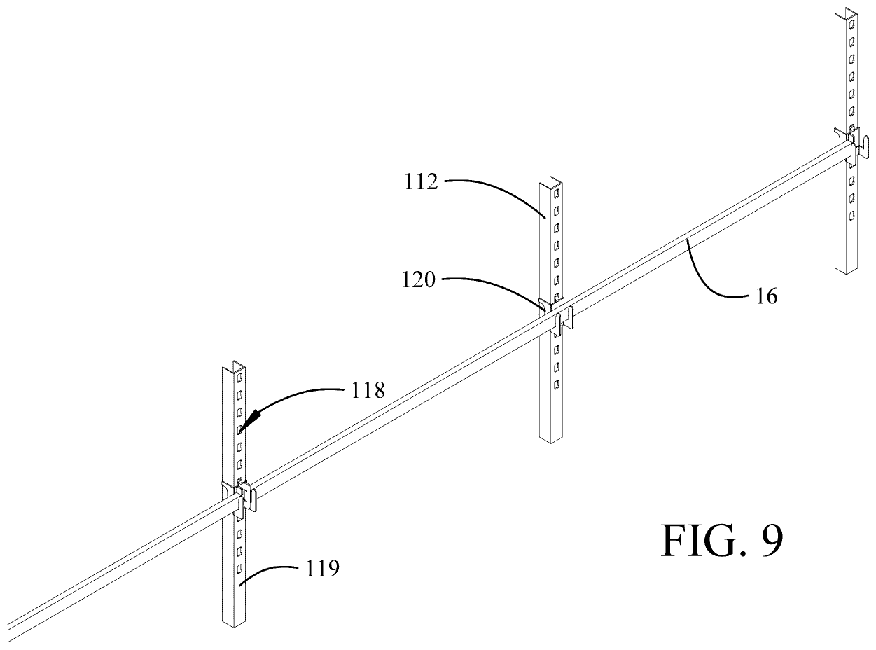

A second implementation of a hanger tube support bracket 120 is shown in FIG. 9 for use with upright Unistrut columns 112. The upright Unistrut columns 112 have a single vertical array of engagement apertures 118 in the web 119 of the columns to secure the hanger tube support brackets 120 to support the hanger tubes 16 to form the cannabis drying support system.

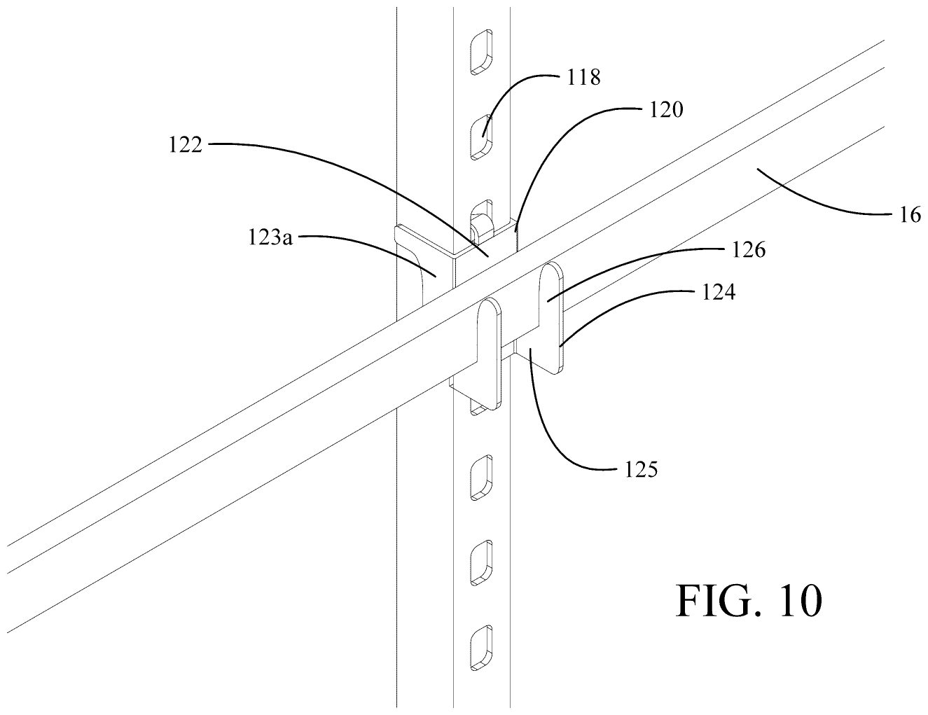

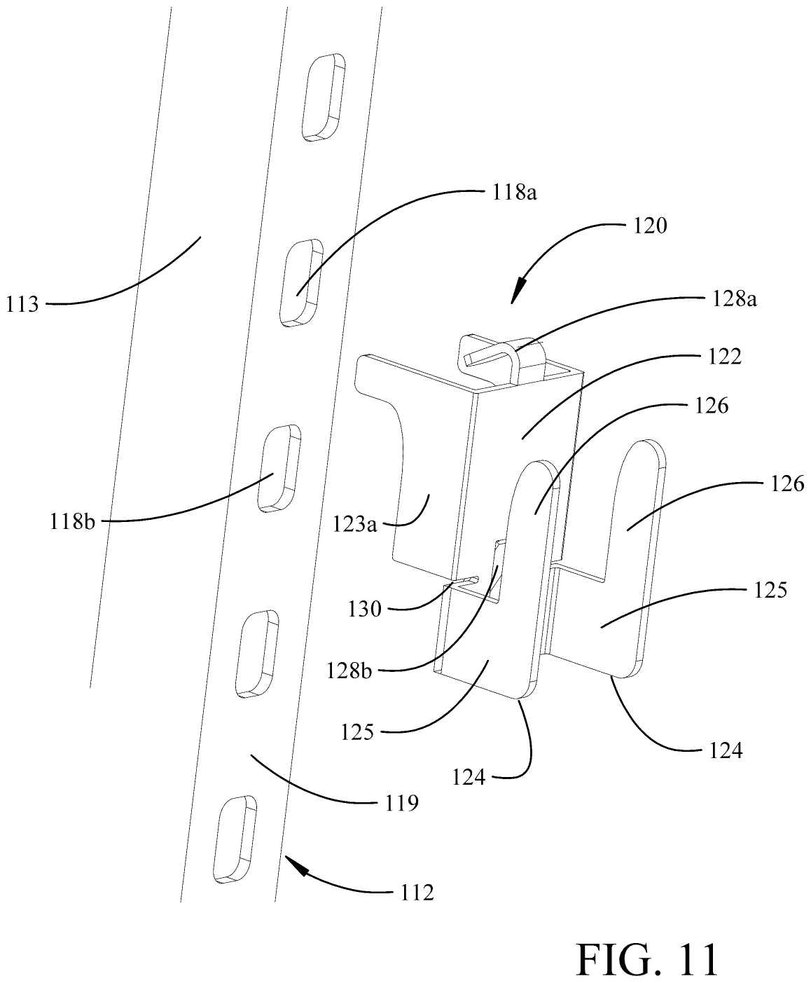

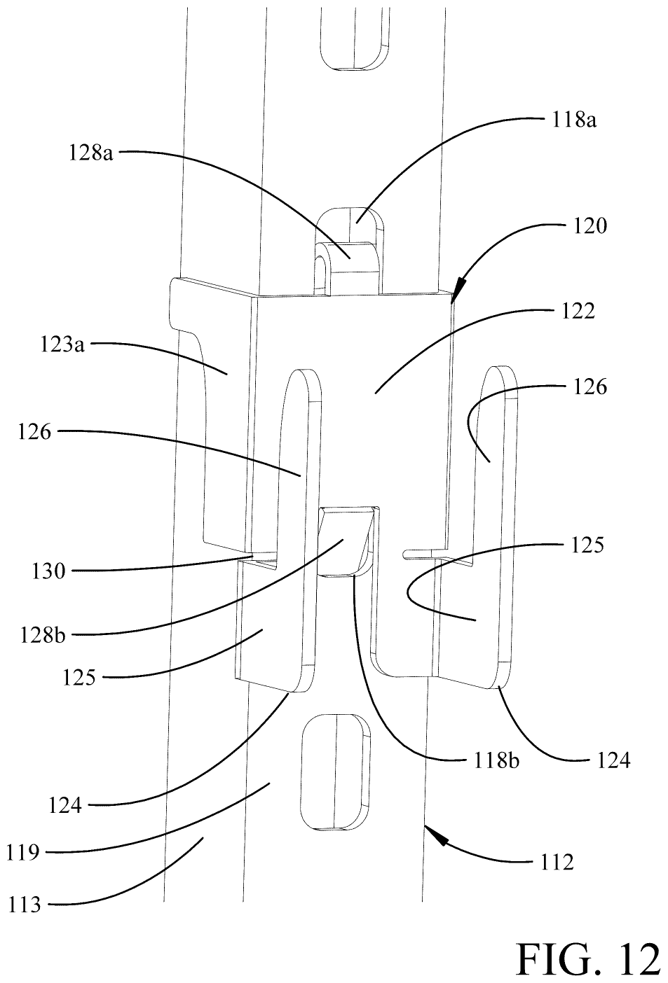

As seen in greater detail in FIG. 10, FIG. 11 and FIG. 12, the second exemplary implementation of the hanger support brackets 120 have a body flange 122 with forwardly extending tube support hooks 124 having horizontal arms 125 and risers 126 to support and constrain the hanger tubes 16. An upper engagement tang 128a and a lower engagement tang 128b extend rearwardly from the body flange 122, the opposite direction from the support hooks with respect to the body flange. Side flanges 123a and 123b also extend rearwardly from lateral extents 121a and 121b of body flange 122 to engage column sides 113 extending from the web 119 of the Unistrut columns. The Unistrut columns have a single vertical array of engagement apertures 118 spaced to provide vertical adjustments of the brackets. The engagement apertures 118 shown in the drawings have an oblong shape with a width in which the upper and lower engagement tangs 128a and 12b are sized to be received.

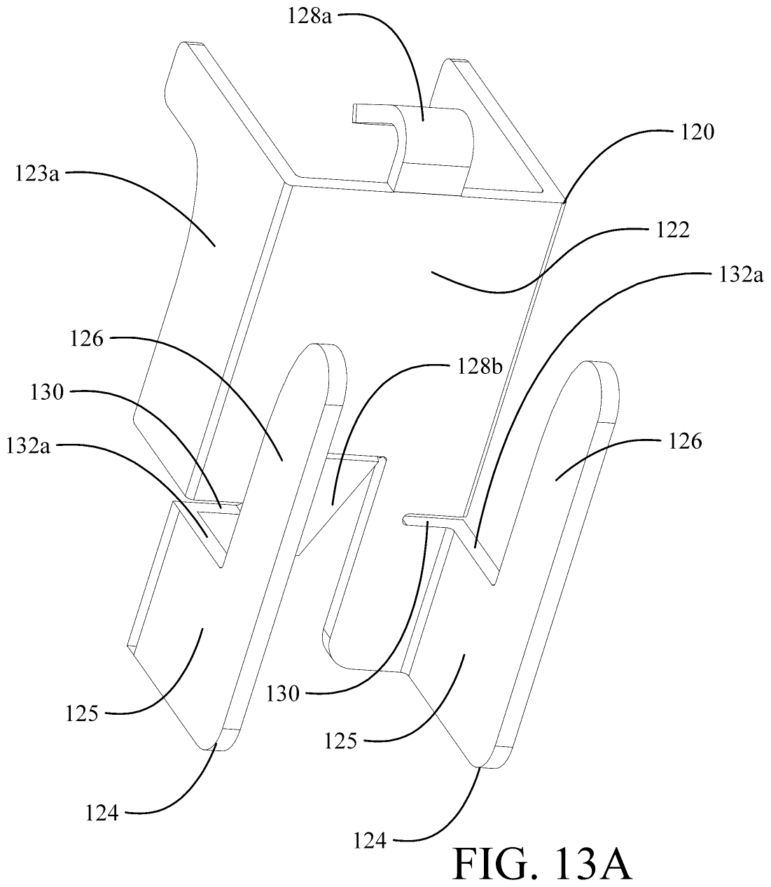

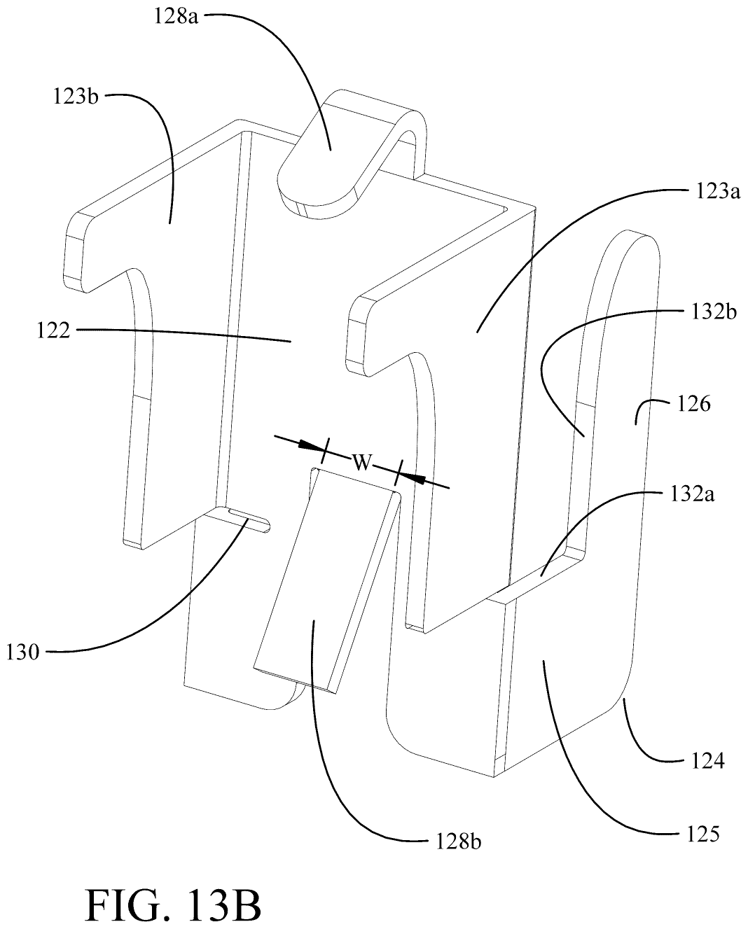

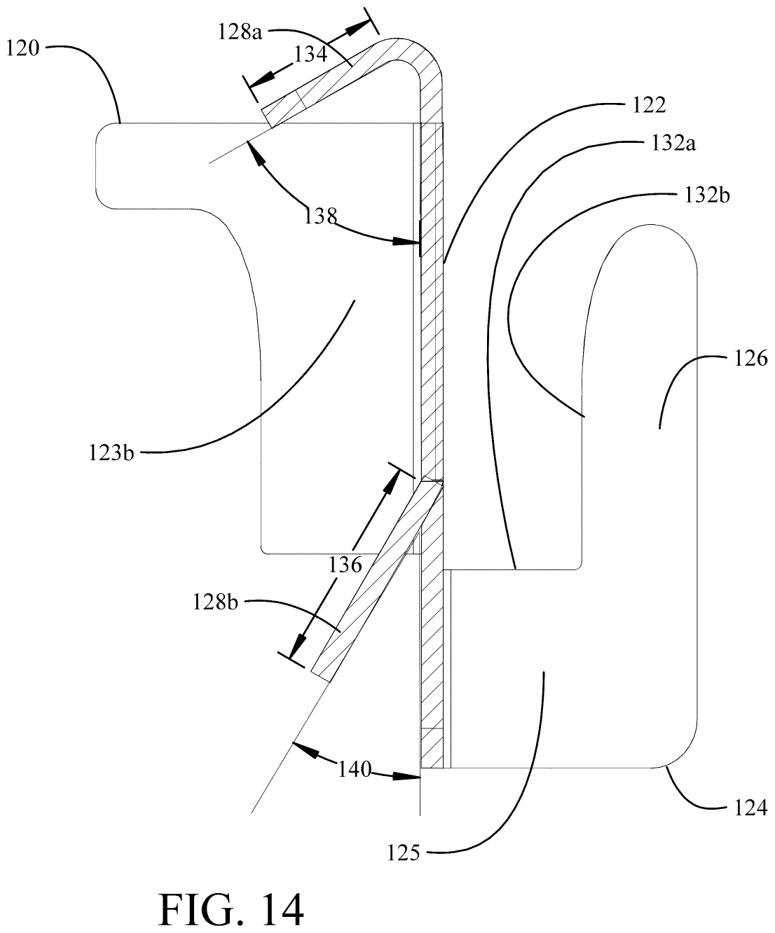

Details of the second exemplary implementation of the hanger tube support bracket 120 are shown in FIGS. 13A, 13B and 14. In the example implementation the hanger support bracket 120 is formed from a flat blank with the support hooks 124 bent forwardly from the body flange 122 and the side flanges 123a and 123b bent rearwardly from the body flange 122. The support hooks may be cut from the material adjacent the side flanges in the flat blank using water jet or laser cutting for best efficiency. Reliefs 130 in the body flange may be present to facilitate bending.

The support hooks 124 have an upper surface 132a on the horizontal arms 125 to support a lower surface 17a (seen in FIG. 2) of the hanger tube 16. A rear surface 132b on the risers 126 constrains a forward surface 17b (seen in FIG. 2) on the hanger tube 16.

As best seen in FIG. 14, the upper and lower engagement tangs 128a and 128b are also formed from the flat blank and cut to have a width W (seen in FIG. 13B) sized to facilitate insertion into the vertically spaced pairs of engagement apertures 118a and 118b. The lower engagement tang 128b has a first length 134 which is greater than a second length 136 of the upper engagement tang 128a and a first engagement angle 138 to which the upper engagement tang 128a is bent may be less than a second engagement angle 140 to which the lower engagement tang 128b is bent to provide functionality for insertion into the engagement apertures to be described subsequently.

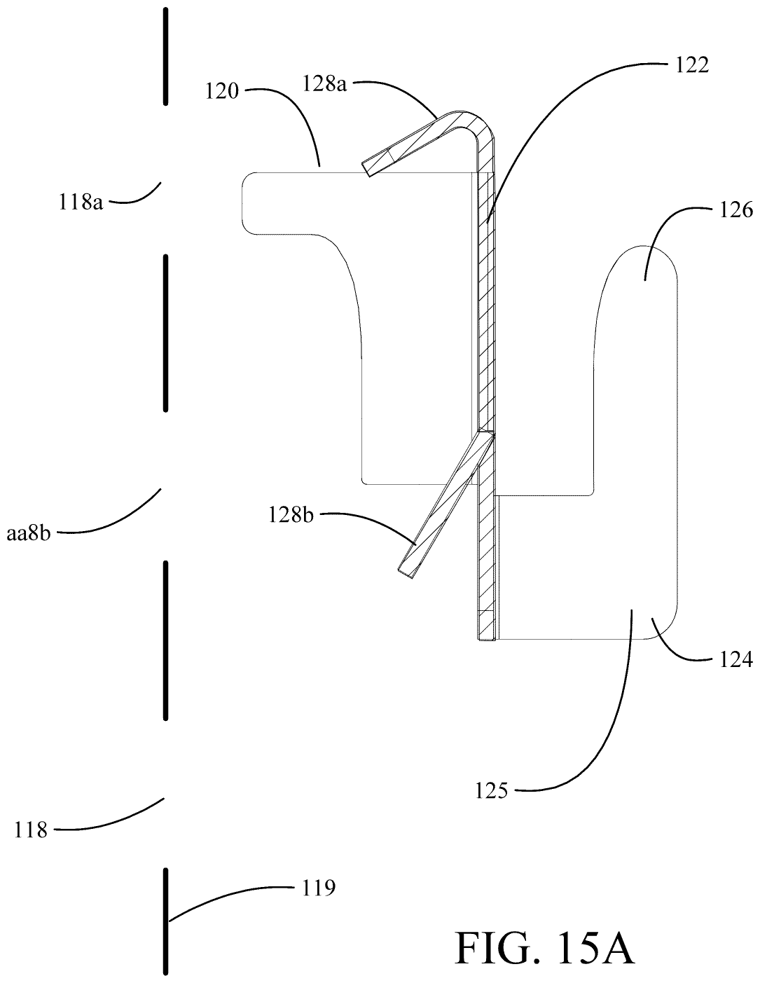

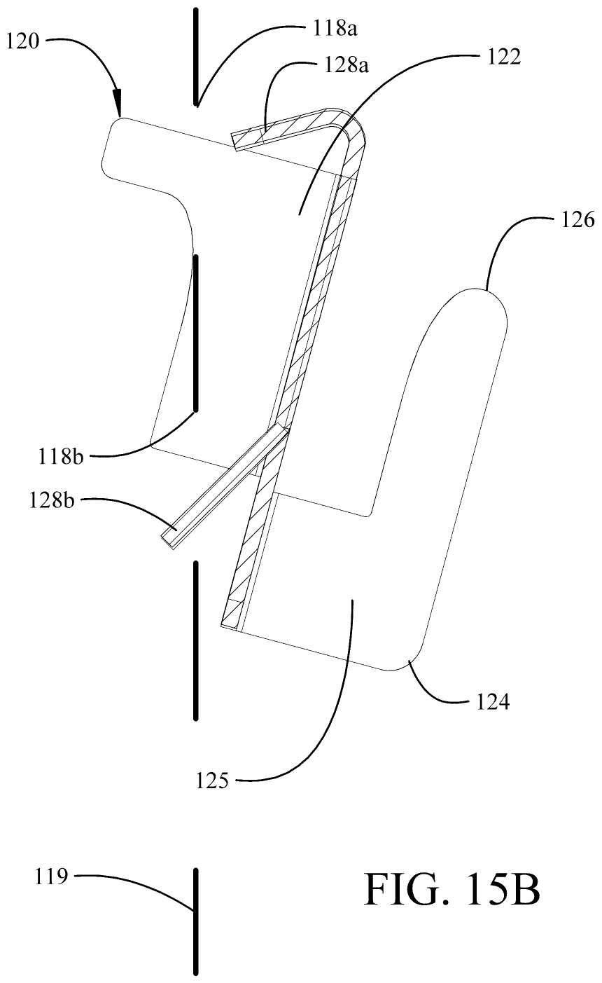

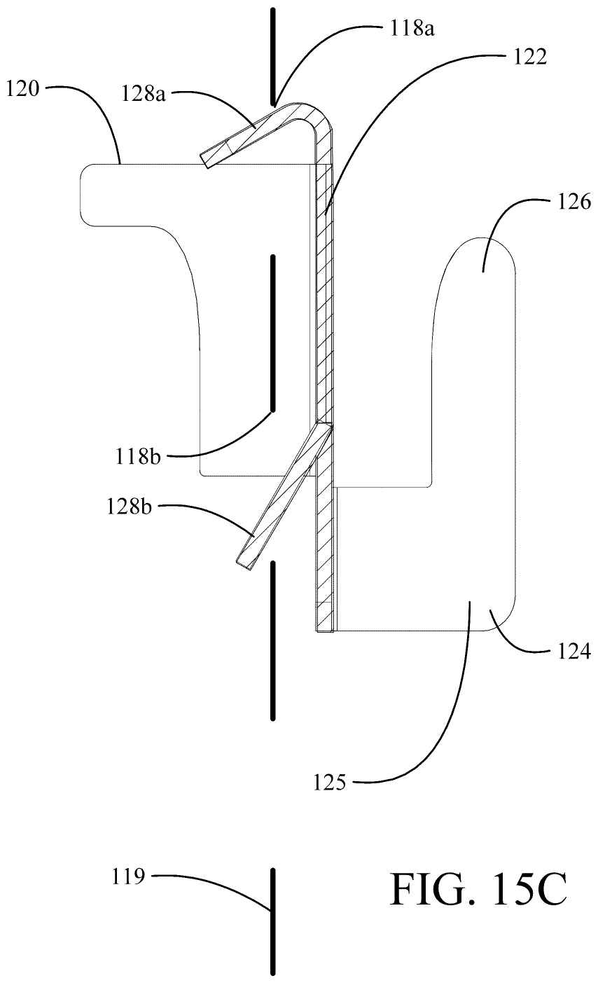

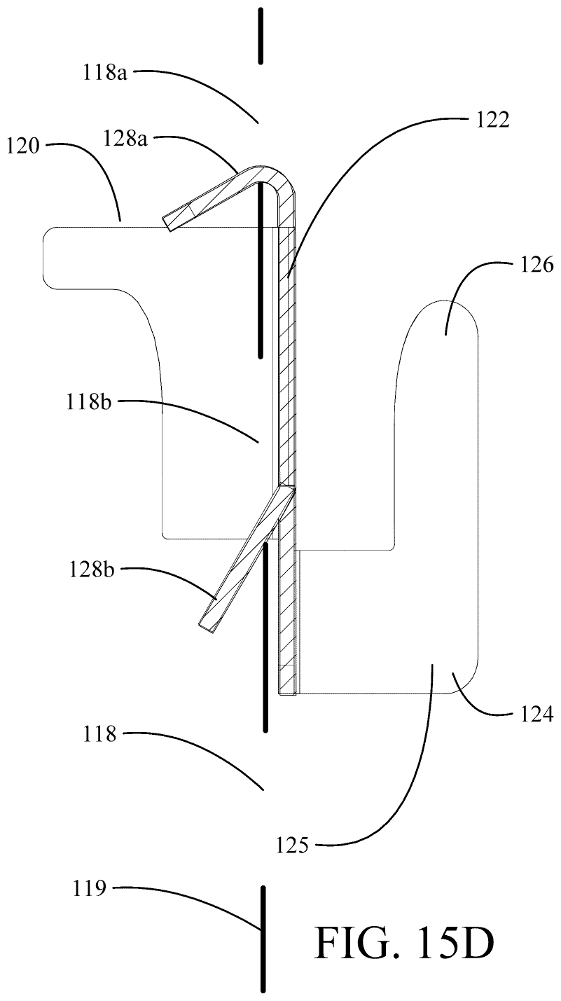

The removable support brackets 120 are attached to the upright columns as shown in FIGS. 15A-15D. As seen in FIG. 15A, support bracket 120 is positioned with the engagement tangs 128a and 128b adjacent to the associated pairs of engagement apertures 118a and 118b (a facsimile of the web 119 of the upright column shown with only the engagement apertures 118a and 118b and any intermediate engagement apertures deleted for clarity). As seen in FIG. 15B, the support bracket is rotated to allow initial insertion of the longer lower engagement tang 128b into the lower engagement aperture 118b. This allows the shorter upper engagement tang 128a to begin insertion into the upper engagement aperture 118a while closely clearing edges of the upper engagement aperture 118a.

As seen in FIG. 15C, the support bracket 120 is then rotated back to substantially vertical while beginning to lower the bracket to engage the web 119 of the column surrounding a lower portion 142 of the lower engagement aperture 118b with a lower forward surface 144 of the lower engagement tang 128b.

As seen in FIG. 15D, upon completion of the downward travel of the support bracket, the web 119 of the column is captured by the upper engagement tang 118a with an upper forward surface 146 engaging a lower portion 148 of the upper engagement aperture 118a and the web 119 is also engaged by lower engagement tang 128b with lower forward surface 144 engaging the lower portion 142 of lower engagement aperture 118b.

Rotation of the support bracket 120 places the side flanges 123a and 123b in contact with the sides 113 of the Unistrut column 112 providing lateral stability.

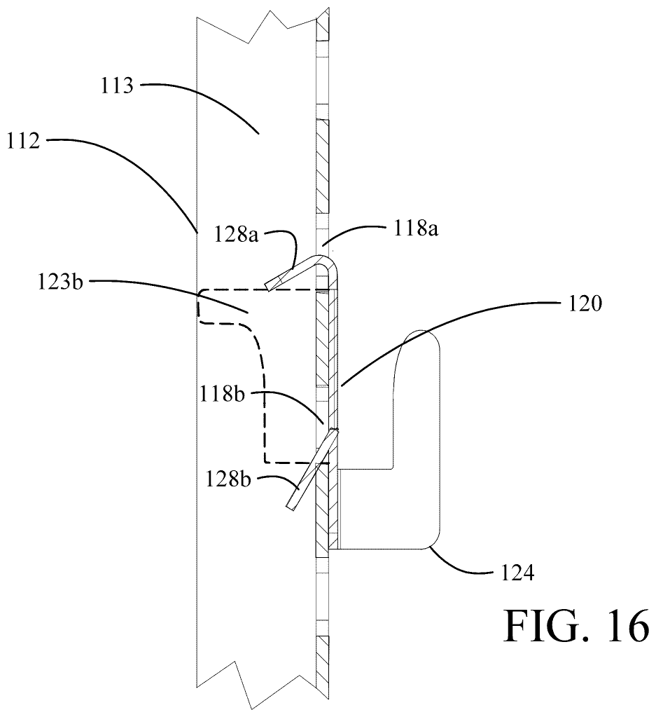

FIG. 16 is a side section view of the Unistrut upright column and fully engaged second implementation of the engagement bracket.

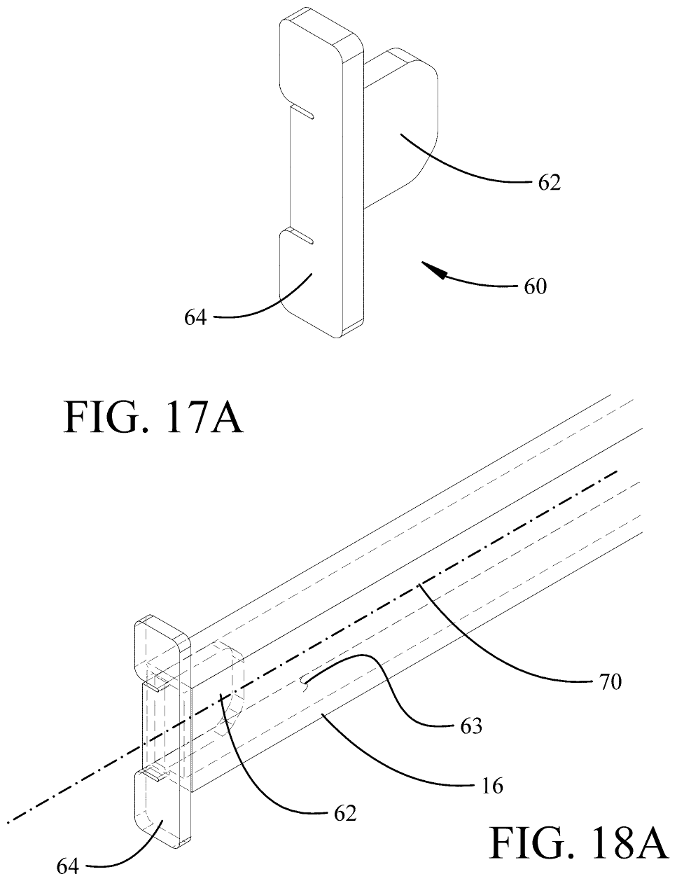

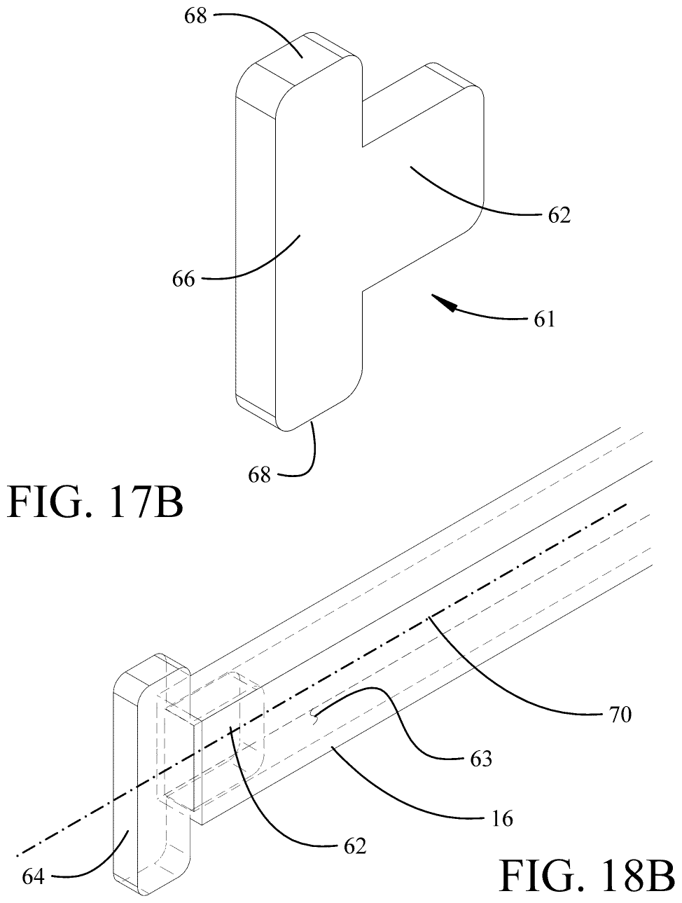

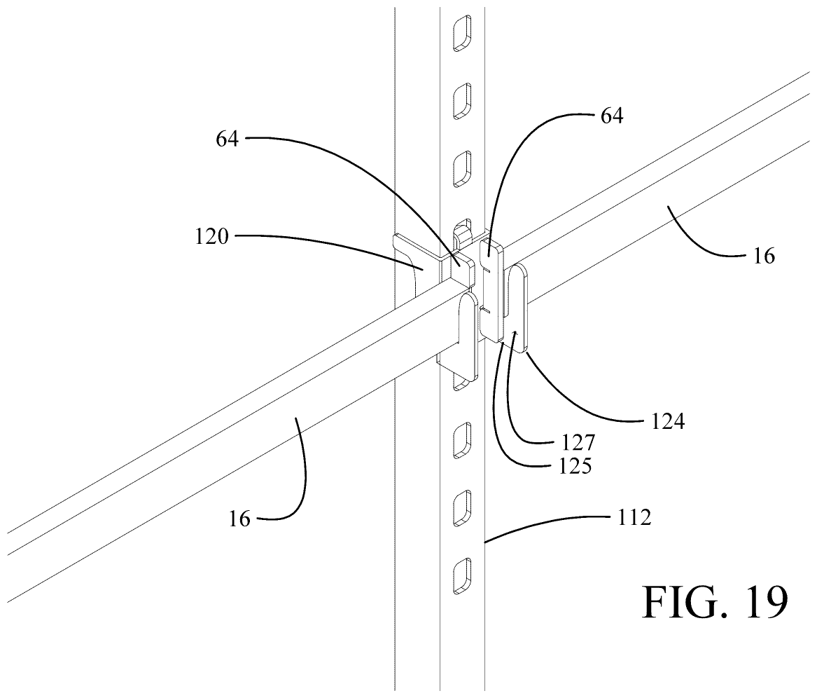

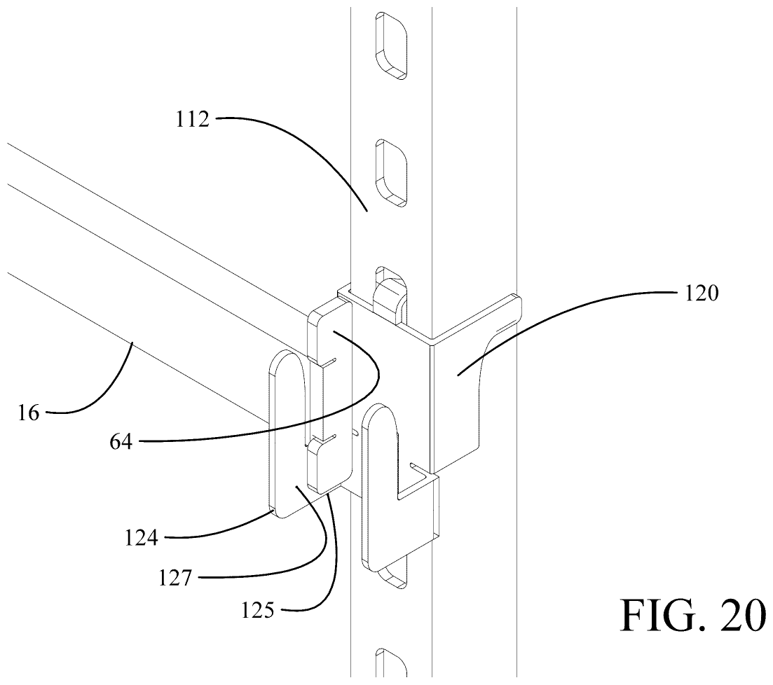

In certain configurations of the frames, it may be desirable to terminate the hanger tubes 16 at the engagement bracket. The hanger tube 16 has a rectangular section with an interior cavity 63 as seen in FIG. 2. FIG. 17A is a pictorial front view of an implementation of an endplate 60 for the hanger tube 16 received in the exemplary implementations of the bracket (shown as an example with the second implementation of the tube support bracket 120), The end plate 60 has a body 62 with a rectangular cross section configured to be engaged in the interior cavity 63 of the hanger tube 16. The body may be chamfered to ease insertion into the interior cavity 63 For the example shown, a friction fit of the rectangular body 62 in the cavity 63 is employed. In certain configurations, dimples or other mating structural features between the rectangular body 62 and interior cavity 63 may be employed or screws may be inserted through the tube 16 into the rectangular body 62. In a first implementation, a lateral flange 64 extends outward from one side of the rectangular body 62 to be received against an interior surface 127 of the horizontal arm 125 of the engaging tube support hook 124 as seen in FIGS. 19 and 20. The end plate 60 is semi-symmetrical allowing a 180° of the end plate 60 about a central axis 70 of the interior cavity 63 prior to insertion into the cavity to accommodate engagement of a left or right end of the hanger tube 16 to the corresponding tube support hook 124. In an exemplary fabrication, lateral flange 64 is created by laser or waterjet cutting the flange profile from the rectangular body 62 and bending the lateral flange 90°.

In an alternative implementation of the endplate 61 seen in FIG. 17B, a flange 66, coplanar to the rectangular body 62, has ears 68 extending vertically from the body 62 to engage the interior surface 127 of the horizontal arm 125 of the support hook 124.

FIG. 18A is a pictorial right front view of the endplate 60 inserted in a hanger tube. FIG. 18B is a pictorial right front view of the endplate 60 inserted in a hanger tube

FIG. 19 is a pictorial left front view of a tube support bracket 120 with engaged endplates 60 on both the right and left ends of separate hanger tubes 16 and received on the second exemplary implementation of the bracket.

FIG. 20 is a pictorial right front view of a tube support with an engaged endplate as a termination received on the second exemplary implementation of the bracket.

Having now described various embodiments of the invention in detail as required by the patent statutes, those skilled in the art will recognize modifications and substitutions to the specific embodiments disclosed herein. Such modifications are within the scope and intent of the present invention as defined in the following claims. Definition of relative geometrical positions such as “upper”, “lower”, “inner”, “outer”, “left”, “right”, “front”, “rear” and similar terms are dependent on the specific embodiments and orientations disclosed herein and are not limiting with respect to the claimed structure.

1. A hanger tube support bracket comprising:
a body flange;
a pair of tube support hooks forwardly extending from the body flange;
an upper pair of engagement tangs and a lower pair of engagement tangs extending rearwardly from the body flange to be received in corresponding upper and lower pairs of engagement apertures in a web of an upright column of a support frame, the upper pair of engagement tangs having upper engagement slots adapted to capture the web with a lower edge of the lower pair of engagement apertures abutting an upper extent of the upper engagement slots and the lower pair of engagement tangs having lower engagement slots adapted to capture the web with a lower edge of the lower pair of engagement apertures abutting an upper extent of the lower engagement slots.

2. The hanger tube support bracket as defined in claim 1 wherein each of the pair of tube support hooks comprises a horizontal arm and a riser to support and constrain a hanger tube.

3. The hanger tube support bracket as defined in claim 1 wherein the upper and lower pairs of engagement tangs are sized to facilitate insertion into the vertically spaced pairs of engagement apertures and the lower pair of engagement tangs have a first length which is less than a second length of the upper pair of engagement tangs.

4. The hanger tube support bracket as defined in claim 3 wherein a lower portion of the upper pair of engagement tangs is beveled or filleted from front to rear.

5. The hanger tube support bracket as defined in claim 4 wherein a lower portion of the lower pair of engagement tangs is beveled or filleted from front to rear.

6. The hanger tube support bracket as defined in claim 5 further comprising a relief ramp on each of the lower pair of engagement tangs receivable relative to an upper edge on each of the lower pair of engagement apertures to mirror close clearance or engagement of the filleted lower portion of the upper pair of engagement tangs on a bottom edge of the upper pair of engagement apertures.

7. A hanger tube support bracket comprising:
a body flange;
a pair of tube support hooks forwardly extending from the body flange;
an upper engagement tang and a lower engagement tang extending rearwardly from the body flange to be received in corresponding upper and lower engagement apertures in a web of an upright column of a support frame, the upper engagement tang having an upper forward surface engaging the web surrounding a lower portion of the lower engagement aperture and the lower engagement tang having a lower forward surface engaging the web surrounding a lower portion of the lower engagement aperture; and,
side flanges extending rearwardly from body flange to engage column sides extending from the web of the upright columns.

8. The hanger tube support bracket as defined in claim 7 wherein each of the pair of tube support hooks comprises a horizontal arm and a riser to support and constrain a hanger tube.

9. The hanger tube support bracket as defined in claim 7 wherein the upper and lower engagement tangs are sized to facilitate insertion into the vertically spaced engagement apertures and the lower engagement tang has a first length which is longer than a second length of the upper engagement tang.

10. The hanger tube support bracket as defined in claim 9 wherein a first engagement angle to which the upper engagement tang is bent from the body flange may be less than a second engagement angle to which the lower engagement tang is bent from the body flange to provide functionality for insertion into the upper and lower engagement apertures.

11. A cannabis drying support system comprising:
a support frame having at least two upright columns each upright column having upper and lower pairs of engagement apertures in a web;
at least one hanger tube extending between the at least two upright columns;
a plurality of hanger tube support brackets, each having:
a body flange;
a pair of tube support hooks forwardly extending from the body flange, each of the pair of tube support hooks comprises a horizontal arm and a riser to support and constrain the hanger tube;
an upper pair of engagement tangs and a lower pair of engagement tangs extending rearwardly from the body flange to be received in corresponding upper and lower pairs of engagement apertures in the web of the upright column of the support frame, the upper pair of engagement tangs having upper engagement slots adapted to capture the web with a lower edge of the lower pair of engagement apertures abutting an upper extent of the upper engagement slots and the lower pair of engagement tangs having lower engagement slots adapted to capture the web with a lower edge of the lower pair of engagement apertures abutting an upper extent of the lower engagement slots.

12. A cannabis drying support system comprising:
a support frame having at least two upright Unistrut columns each upright Unistrut column having upper and lower engagement apertures in a web;
at least one hanger tube extending between the at least two upright Unistrut columns;
a plurality of hanger tube support brackets, each support bracket having:
a body flange;
a pair of tube support hooks forwardly extending from the body flange, each of the pair of tube support hooks having a horizontal arm and a riser to support and constrain the hanger tube;
an upper engagement tang and a lower engagement tang extending rearwardly from the body flange to be received in corresponding upper and lower engagement apertures in the web of the upright Unistrut column of the support frame, the upper engagement tang having an upper forward surface engaging the web surrounding a lower portion of the lower engagement aperture and the lower engagement tang having a lower forward surface engaging the web surrounding a lower portion of the lower engagement aperture; and,
side flanges extending rearwardly from body flange to engage column sides extending from the web of the upright columns.

13. A method for forming a hanger tube support bracket, the method comprising:
cutting a flat blank forming a body flange, two support arms, and at least one upper engagement tang and at least one lower engagement tang;
bending the support arms forwardly from the body flange;
bending the at least one upper and at least one lower engagement tangs rearwardly from the body flange; and
engaging the at least one upper engagement tang in an upper engagement aperture in a column and the at least one lower engagement tang in a lower engagement aperture in the column.

14. The method as defined in claim 13 further wherein the step of cutting the flat blank includes cutting side flanges and further comprising;
bending the side flanges rearwardly from the body flange; and
engaging sides of the column with the side flanges for lateral stability.
